(19) United States
(12) Patent Application Publication
(10) Pub. No.: US 2013/0110668 A1
(43) Pub. Date: May 2, 2013

(54) USER SOLUTIONS ONLINE PURCHASING

(71) Applicants: Melissa Christine Derville Hart, Cornelius, NC (US); Katherine Kei-Zen Dintenfass, Charlotte, NC (US); James Arthur Blanchard, Midland, NC (US); Kim Elizabeth Childress, Charlotte, NC (US); Joseph Neil Johansen, Rock Hill, SC (US); Preston J. Taylor, Stallings, NC (US); Anh Aragon Mooney, Rolesville, NC (US); Lisa L. Bogart, Williamsville, NY (US); Kevin Clark May, Waxhaw, NC (US)

(72) Inventors: Melissa Christine Derville Hart, Cornelius, NC (US); Katherine Kei-Zen Dintenfass, Charlotte, NC (US); James Arthur Blanchard, Midland, NC (US); Kim Elizabeth Childress, Charlotte, NC (US); Joseph Neil Johansen, Rock Hill, SC (US); Preston J. Taylor, Stallings, NC (US); Anh Aragon Mooney, Rolesville, NC (US); Lisa L. Bogart, Williamsville, NY (US); Kevin Clark May, Waxhaw, NC (US)

(73) Assignee: BANK OF AMERICA CORPORATION, Charlotte, NC (US)

(21) Appl. No.: 13/359,551

(22) Filed: Jan. 27, 2012

Related U.S. Application Data
(60) Provisional application No. 61/554,268, filed on Nov. 1, 2011.

(51) Int. Cl. G06Q 30/06

(52) U.S. Cl. 705/26.5

(57) ABSTRACT

A method, apparatus, computer-readable medium and system are disclosed for presenting product and service offerings to a user. In some embodiments, dynamic messaging may be used to facilitate comparison shopping, allowing a user to select a product or service that best meets the user's needs. In some embodiments, the terms or conditions associated with an offer may be based on a user's relationship with the product or service provider. For example, accounts that the user has with the provider may be analyzed to determine what terms or conditions the user is eligible for. The accounts may be linked to one another, optionally upon the request of the user, to facilitate the analysis. In some embodiments, the product or service offerings may be associated with a financial institution, such as a bank. Suggested or recommended terms and conditions may be dynamically updated as a user progresses through an application process.

### CROSS-REFERENCE(S) TO RELATED APPLICATIONS

This application claims the benefit of U.S. Provisional Application No. 61/554,268, filed Nov. 1, 2011, entitled “User Solutions Online Purchasing,” and identified by attorney docket no. 007131.01129. The content of the foregoing application is incorporated herein by reference.

### FIELD

Aspects of the present disclosure relate to computer technologies. More specifically, aspects of this disclosure relate to provisioning of customizable products and services.

### BACKGROUND

Improvements in computing technologies have changed the way people interact with one another, as well as how people acquire products and services and conduct business. For example, a user may use a web browser to view a bank statement, to pay a bill, and to apply for a mortgage or loan.

From the perspective of a product/service provider, difficult decisions frequently need to be made as to whether to extend a product or service to a particular user (which may include a person, a business, a partnership, etc.). For example, a bank may not know what terms or conditions to offer to a user in connection with one or more accounts. This may be at least partially a result of the structure of the bank. For example, a bank's organization may be thought of as a silo, where each department, business line, or group supports its own goods or services independent of other departments, business lines, or groups. Thus, a first department may support a first product or service (e.g., checking), while a second department may support a second product or service (e.g., investments). Such a structure may inhibit information sharing between departments. As a further impediment, it may be difficult to link user accounts together. For example, there may be risks involved in linking user account together, which may partially be a result of legal or regulatory compliance measures that need to be met.

From the perspective of a user (e.g., a customer or potential customer), the user will frequently like to take advantage of product or service offerings that provide the user with better terms and conditions, such as the highest grade product or service for the lowest cost. For example, in the context of banking, a user may desire any number of services, such as free checking, online bill pay, etc. The user might not be aware of what options are available, and any account customization processes that may currently be in place are inefficient for both the user and the bank.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to an apparatus, computer-readable media, a method, and a system for targeting users with one or more product or service offerings. In some embodiments, a user might not have previously engaged in a transaction with, or established an account with, a product/service provider. In some embodiments, the user may have a history or relationship with the product/service provider. In some embodiments, one or more user accounts with the product/service provider may be linked. The linkage may be used to generate one or more product or service offerings.

In some embodiments, the product/service provider may generate an offer. The offer may include one or more products or services. For example, in a banking context, the offer may include terms and conditions associated with a package of banking services, such as checking, savings, debit and credit. In some embodiments, the generation of the offer may be at least partially automated. In some embodiments, the offer may be generated in response to an inquiry or application generated and submitted by a user.

In some embodiments, a pricing model may be used. For example, in a banking context, a user may be provided selectable options to facilitate customizing a bank account. In response to choosing a particular option or setting, an updated term or condition (e.g., an updated price) associated with an offer may be presented in real-time, or substantially real-time. A user may iteratively customize an account based on feedback received at various stages in order to arrive at an optimum configuration, such as a set of account options that best meets the particular user's banking needs as determined by the user, by the bank, or by a third party.

In some embodiments, messaging may be used. In some embodiments, the messaging may be at least partially dynamic in nature. For example, messages may be provided to a user at log-in, or at any other time. The messages may present suggested or recommended products or services, or terms or conditions associated therewith. The messages may be based at least in part on a relationship that a user has with a product/service provider, accounts that the user has with the product/service provider, etc. In some embodiments, the messaging may facilitate comparison shopping.

### BRIEF DESCRIPTION OF THE DRAWINGS

The present disclosure is illustrated by way of example and not limited in the accompanying figures in which like reference numerals indicate similar elements.

FIG. 1 illustrates an example computing environment in which various aspects of the disclosure may be implemented.

FIG. 2 illustrates a simplified diagram of a system in which various aspects of the disclosure may be implemented.

FIGS. 3-4 illustrate flow diagrams for setting up an account in accordance with one or more aspects of this disclosure.

### DETAILED DESCRIPTION

In the following description of the various embodiments, reference is made to the accompanying drawings, which form a part hereof, and in which is shown by way of illustration various embodiments in which one or more aspects of the disclosure may be practiced. It is to be understood that other embodiments may be utilized and structural and functional modifications may be made without departing from the scope of the present disclosure.

Various connections between elements are discussed in the following description. These connections are general and, unless specified otherwise, may be direct or indirect, wired or wireless, and this specification is not intended to be limiting in this respect.

In accordance with various aspects of this disclosure, apparatuses, systems, computer-readable media, and methods are described for providing product and service offerings. For illustrative purposes the product/service provider discussed throughout the below description is a bank, and the bank and/or a user are determining what terms or conditions to associate with one or more accounts. Those skilled in the art will realize that the described aspects of the disclosure are not limited to banking products and services. Aspects of the disclosure are directed to products and services outside of a banking context.

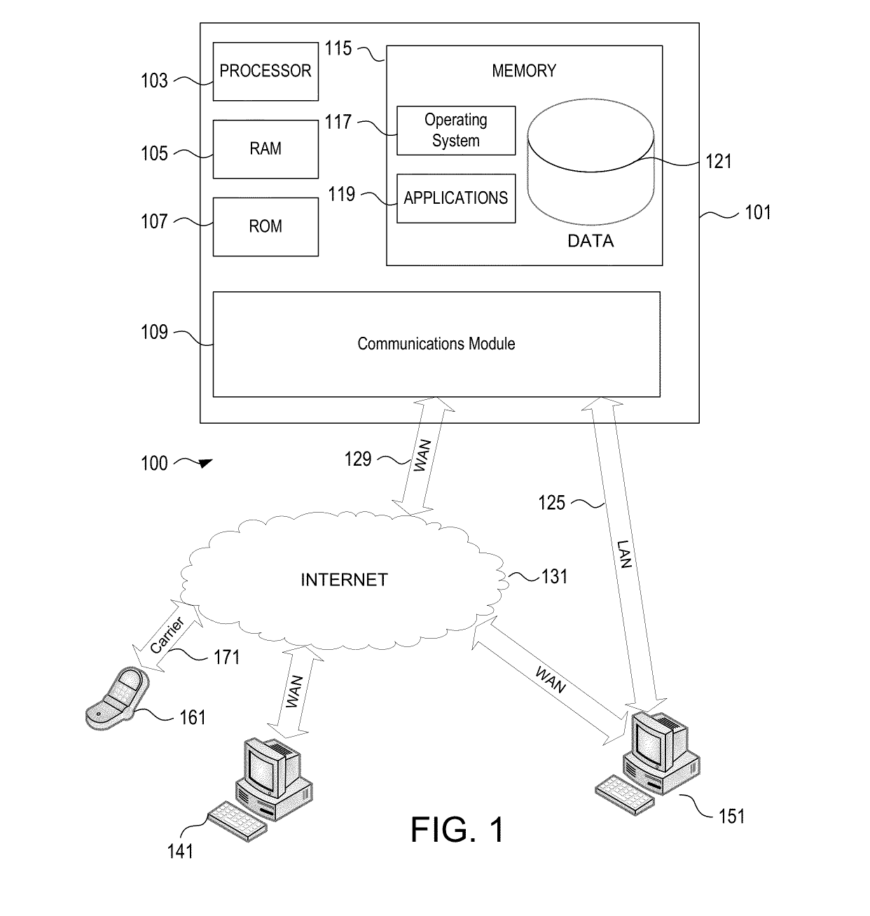

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 typically includes a variety of computer-readable media. Computer-readable media may be any available media that may be accessed by computing device 101 and include both volatile and nonvolatile media, removable and non-removable media. By way of example, and not limitation, computer-readable media may comprise a combination of computer storage media and communication media.

Computer storage media include volatile and nonvolatile, removable and non-removable media implemented in any method or technology for storage of information such as computer-readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer-readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 825 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as one or more computer-readable media storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 101. Such a processor may execute computer-executable instructions stored on a computer-readable medium.

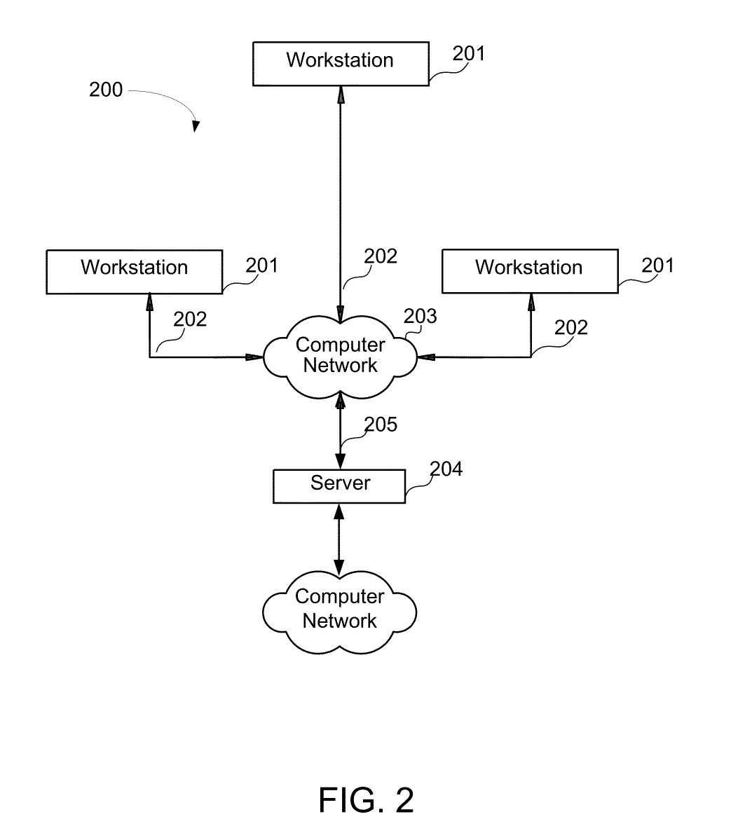

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

In some embodiments, a user may be interested in opening an account with a bank. In some embodiments, the user may already have a pre-existing account with the bank. In some embodiments, the user and the bank might not have a pre-existing relationship, e.g., the user may be new to the bank.

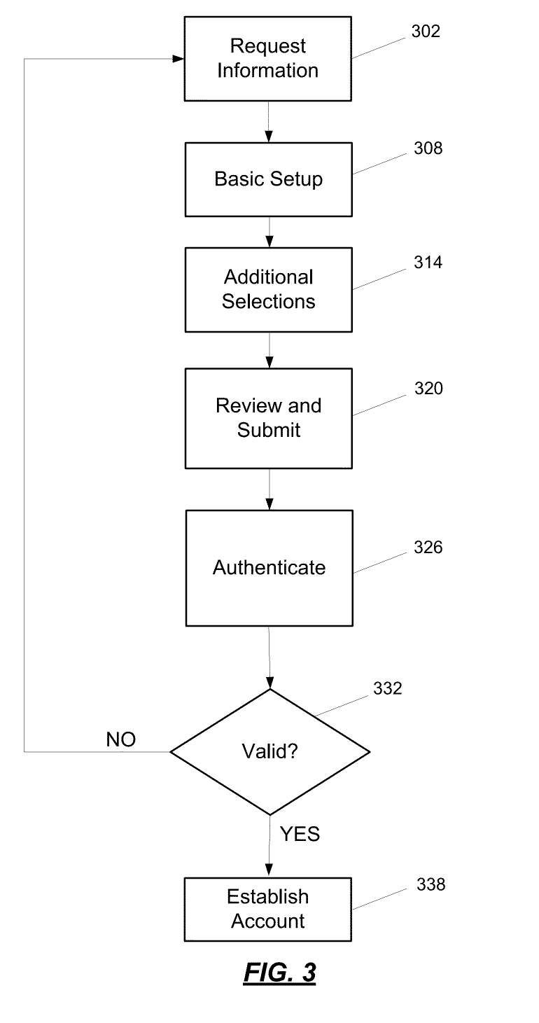

FIG. 3 illustrates a method that may be used to establish a user account with a bank. In some embodiments, the method of FIG. 3 may execute in response to a user navigating to a particular web page or site, such as a web page sponsored by a bank. In some embodiments, the method of FIG. 3 may execute as part of an advertising or solicitation campaign on the part of the bank to attract new business. In this regard, an advertisement may be sent to an email address of the user, be included as a banner in connection with one or more web pages, etc., for selection by the user. In some embodiments, the method of FIG. 3 may be part of an application process to establish a user account with the bank.

In step 302, information may be requested of the user. For example, in some embodiments the user may be asked to log-in to a banking website, which may include the user supplying a username, a password, a personal identification number (PIN), an account number, etc. Other security features may include asking the user to provide answers to questions that might be difficult for anyone other than the user to answer correctly (e.g., mother's maiden name, where the user went to high school, the user's favorite uncle's name, etc.). In some embodiments, the requested information of step 302 may include one or more of a name, a social security number, a residential or mailing address, an email address, a telephone number, date of birth, citizenship, identification of an employer, educational history, listing of dependents, an identification of one or more additional users to be associated with the account, etc.

In step 308, one or more fields of an application may be populated based at least in part on the information requested in connection with step 302. For example, a form may be populated with data including the user's name, social security number, address, etc.

In step 314, the user may supply additional information, potentially based on a prompt from the bank. For example, the user may indicate an initial amount to deposit in the account (which may originate from an existing account the user has with the bank, or another account that may be associated with another bank), an identification of a security deposit, whether to enable online banking, online paperless statements, whether to link one or more accounts to the account being opened, whether a combined statement (e.g., across one or more users, or across one or more linked accounts) should be used, whether protection is desired (including an identification of one or more accounts to draw from), automatic savings transfers (e.g., a “keep the change” type of program), whether to transfer a balance from one account to another, whether to enable automatic bill pay (potentially at a specified frequency, e.g., monthly), etc. In connection with an option to link accounts, in some embodiments, the bank or a third party may determine that only a subset of a user's accounts may be available for linking. In some embodiments, all of the user's accounts may be available for linking, which may optionally be determined by the bank, by the user, or by a third party.

In step 320, the bank may provide the user with a summary or recap of the information the user supplied in connection with steps 302-314. The user may review the summary or recap to confirm that the user's information and selections were as intended. If the user desires to modify one or more values or inputs, the user may do so as part of step 320. As part of step 320, once the user is satisfied with the values/inputs, the user may confirm the selections by pushing an “OK” button, key, or the like. Responsive to the depression, the user's information and selections may be received at the bank for review.

In step 326, the bank may authenticate the user-provided information and selections. The bank may confirm that the information and/or selections conform to what was expected in terms of form and/or substance. For example, the bank may confirm that a user-entered social security number is nine digits in length. As another example, the bank may confirm that the social security number is not identical to a social security number of another user.

In step 332, the bank may determine whether the authentication of step 326 indicates that the user-provided information and/or selections are valid. If the user information/selections are valid (e.g., the “YES” path is taken out of step 332), then flow may proceed to step 338, where an account may be established. As part of step 338, one or more confirmations or receipts may be generated. For example, a communication (e.g., an email, a text message, a voice message, etc.) may be sent to the user, and the communication may include the terms and conditions associated with the account, as well as an identification of the options the user selected for the account. If one or more of the user information/selections are invalid (e.g., the “NO” path is taken out of step 332), then flow may proceed to one or more of the preceding steps (e.g., step 302) to facilitate correction or modification of the information/selections. If the bank is able to determine what the cause of the issue or error was, the bank may provide a suggested or recommended value in connection with the flow from step 332 to, e.g., step 302.

In some embodiments, the method of FIG. 3 may be adapted or modified to facilitate modifying an existing account. For example, the method of FIG. 3 (e.g., step 314) may be used to modify one or more options associated with an existing account, and the modified option(s) may be saved in connection with step 338.

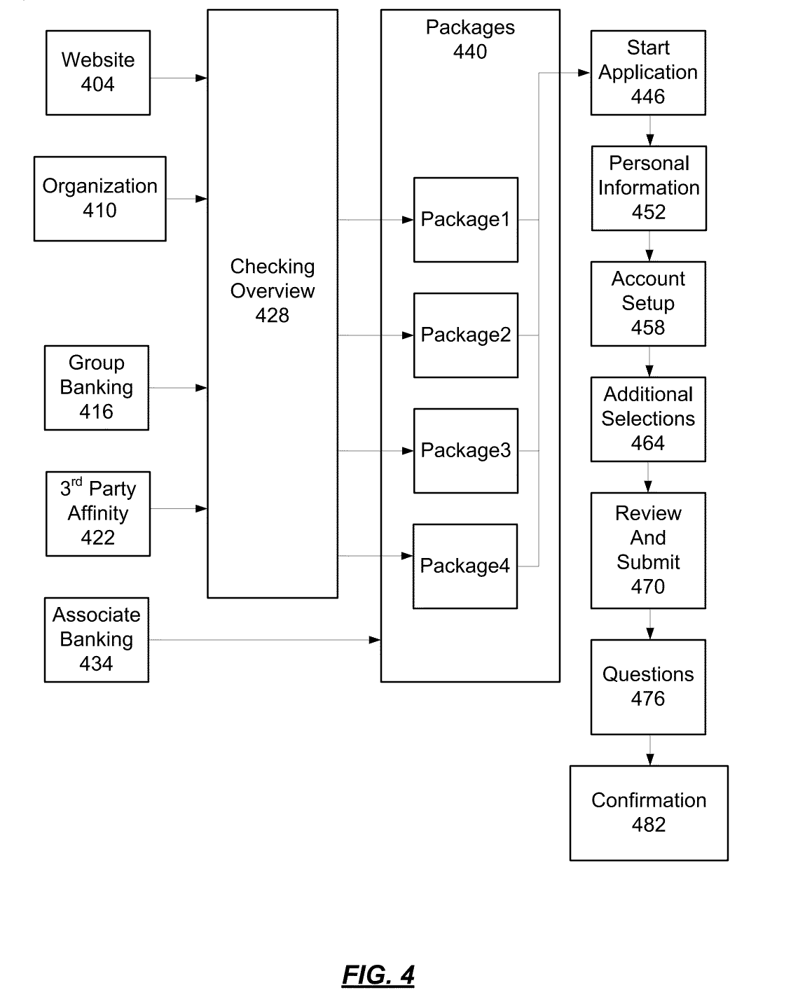

FIG. 4 illustrates a method that may be used to establish a user account with a bank. In some embodiments, one or more aspects of the methods/flows of FIGS. 3 and 4 may be combined.

In step 428, a checking overview may be presented based on one or more inputs. The one or more inputs may be based on, or originate from, one or more of a website 404, an organization 410, a group banking 416, and a third party affinity 422. Website 404 may be associated with the bank or another entity and may provide information associated with banking or market trends, packages that the bank is willing to provide or sponsor, etc. Organization 410 may include one or more organizations, such as military institutions, service organizations, etc., and may include information related to discounts or other terms or conditions that particular organizations are entitled to receive, e.g., by law, by regulation, or in accordance with the bank's policies. Group banking 416 may identify groups, or members of groups, that have enrolled with or otherwise requested banking services on the basis of belonging to a group. Third party affinity 422 may be associated with one or more entities that are in a partnership or alliance with the bank.

Checking overview 428 may analyze the inputs provided by, e.g., website 404, organization 410, group banking 416, and/or third party affinity 422 to drive, or supply input to, one or more packages 440. In some embodiments, packages 440 may also be driven by input received from associate banking 434. In some embodiments, associate banking 434 may be affiliated with an entity that agrees to provide products or services to meet the bank's user's needs.

Four packages (numbered 1-4) are shown in packages 440 in FIG. 4. In some embodiments, any number of packages may be included. Packages 1-4 may be indicative of packaged products or services. For example, packages 1-4 may be associated with various classes or grades of service. In some embodiments, the packages may have associated benefits and/or terms or conditions (e.g., price, etc.).

As shown in FIG. 4, packages 440 may drive, or supply input to, a customization process (reflected via steps 446-482). Steps 446-482 may be used to select and/or customize a package for a user.

In step 446, an application may be started. The application may be associated with a website in some embodiments. In some embodiments, the application may be interactive, and may provide for a dynamic line of questions based at least in part on prior responses provided by a user.

In step 452, the user may supply personal information, optionally based on a request or prompt generated by the application. In some embodiments, the personal information supplied in step 452 may include one or more pieces of information associated with step 302 of FIG. 3 as described above.

In step 458, an initial account setup may be generated. The initial account setup may correspond to one or more of the packages 440. For example, the initial account setup may include products or services, and terms or conditions, associated with package1. In connection with step 458, one or more fields of an application form may be populated and/or presented to the user in a manner similar to step 308 of FIG. 3.

In step 464, one or more additional selections may be received from the user. For example, after reviewing a display screen associated with an application form displayed in connection with step 458, a user may specify that she wants to modify a first term or condition associated with package1. In response to the user's request to modify the first term or condition associated with package1, the bank may: (1) reject the request, (2) accept the request, or (3) conditionally accept the request, subject to the user agreeing to modify a second term or condition associated with package1. In this regard, step 464 may execute repeatedly or iteratively until the user and the bank have reached an agreement regarding the products or services (and the terms and conditions) that are to be provided to the user. Step 464 may also be viewed as a customization of a package, thereby allowing the package to meet the particular user's needs while minimizing the number or complexity of the variables that the user will likely need to consider.

In step 470, a user may review the account information and selections for discrepancies, and may return to previous steps such as 452, 458, or 464 to correct any such discrepancies. As part of step 470, once the user is satisfied that the account information and selections are acceptable, the user may submit (e.g., by pushing an ‘OK’ button, key, or the like) the account information and selections for processing.

In step 476, the user may be asked one or more questions. For example, the user may be asked one or more “out of wallet questions” in order to ensure that the user is who she claims to be. In this manner, protection can be provided against identity theft or the establishment of a fraudulent account. Questions 476 may also provide a user, such as a legitimate user, with the ability to engage a representative of the bank. For example, the user may engage in an online chat session, phone call correspondence, email, etc., with a representative of the bank in order to answer the user's banking questions or in order to allow the bank to collect feedback from the user based on the user's experience with the application. In this manner, the bank can improve the application in the future, thereby enhancing the overall user experience.

In step 482, one or more confirmations may be generated. The confirmation(s) may take the form of a receipt, a stub, or the like. The confirmation(s) may be sent or transmitted to a device associated with the user. For example, the confirmation(s) may be transmitted as an email, a voice message, a text file, etc.

As described above, an account may include one or more product or service offerings, such as support for debit/credit card transactions, checking, bill pay, savings, online banking, investments, and the like.

As described above, the bank may provide one or more products or services to a user based on the user's relationship with the bank. For example, if a user has one or more pre-existing accounts with the bank, the bank may review those accounts to determine whether to extend or enhance the user's services, such as providing an additional account to the user. In this regard, an all-in-one type of solution may be provided for, at least from the perspective of the user, wherein a user may fulfill all her banking product and service needs via one easy-to-use platform. As a result, the user's experience may be enhanced or improved relative to conventional banking environments.

In some embodiments, a relationship between a bank and a user may be analyzed based on the user's existing accounts with the bank. For example, the user's accounts may be linked to one another. The user may choose to link some or all of her accounts upon signing-in to a website associated with the bank, or at some other point in time. In some embodiments, the bank may link the user's accounts in order to provide a product or service that best meets the user's needs, potentially based on one or more algorithms formulated by the bank, the user, or a third party.

In some embodiments, even if the bank's products or services are packaged or bundled for presentation to a user, the products or services may be administered by disparate groups or departments within the bank. Such a practice may facilitate implementation of various aspects of this disclosure with respect to a bank's pre-existing or legacy organization. For example, the bank might not have to undergo a costly reorganization by continuing to allow disparate groups to administer or support particular products or services within a package. In this regard, implementation costs may be minimized.

If the user is new to the bank, standard or customary terms or conditions may initially be used in connection with a new account, potentially subject to modification based on information that the user may provide.

In some embodiments, the user may review the bank-provided terms/conditions, and may request a modification of one or more of the terms/conditions. The bank may review the request, and optionally change another term or condition in response to the user's request. In this regard, the interaction between the user and the bank may take on the form of familiar contracting principles, wherein the user and the bank may engage in one or more negotiations. For example, the user and the bank may generate one or more offers, counter-offers, and/or acceptances. From the perspective of the user, the user may be provided with an updated offer in real-time, or substantially in real-time, based on the modifications requested by the user and bank's feedback in response thereto. In this regard, delays and inefficiencies that otherwise might be present in the negotiation process may be eliminated or minimized.

Aspects of the disclosure may be used to facilitate comparison shopping. For example, as described above a user may weigh one product or service feature (checking features) against another (e.g., online bill pay) to determine a product, service, or package that best meets the user's needs. In some embodiments, a bank may provide suggestions or recommendations to the user regarding one or more options, potentially based on pre-existing accounts or selections.

In some embodiments, the suggestions or recommendations provided by the bank may be responsive to a user request. For example, the user may undertake a review of her bank accounts and may determine that her accounts are deficient in one or more respects. In response to the user request, the bank may perform an analysis of the user's accounts to provide the suggestions or recommendations. In some embodiments, the bank may perform the analysis of the user's accounts independent of any request received from the user. Such features may be used to present options to the user that the user might not otherwise be aware of, optionally in connection with one or more messages (e.g., dynamic messages) that may be presented to a user.

One or more algorithms (or criteria) may be used (or applied) with respect to various aspects of this disclosure. As an illustrative example, if a user has an existing credit card and an existing mortgage account, then the user may be presented with a message (upon log-in to a website, via an email, etc.) to upgrade to a higher-tier account status. Details of the higher-tier account status (e.g., additional checking or saving accounts, potentially at no cost) may also be included in the message to entice the user to agree to the upgrade. The invitation to upgrade to the higher-tier account status may be conditioned on the user agreeing to some other modification to the user's account, such as agreeing to link the user's savings account to the mortgage account to provide for protection, agreeing to only withdraw or deposit funds from/to an automated teller machine (ATM) sponsored by or affiliated with the bank, agreeing to maintain a minimum balance in one or more accounts, agreeing to sign-up for a product or service sponsored by a trading partner of the bank, agreeing to download and use a mobile banking application associated with the bank on a smartphone fabricated by a particular manufacturer, etc. In some embodiments, pricing may be included in one or more messages, or as one or more terms or conditions, in connection with the upgrade.

The methods and features described herein are illustrative. In some embodiments, some of the steps or features (or portions thereof) may be optional. In some embodiments, some of the steps or features (or portions thereof) may execute in an order or sequence different from what is shown. In some embodiments, additional steps or features (not shown) may be included.

As described herein, a user may be provided with an ability to customize a product or service, optionally in connection with a package, that best meets the user's needs. For example, aspects of the disclosure provide an ability to present different pricing, rates, and features based on a location of a device or a user, such as a user's country, region, or state of domicile or residence.

In some embodiments, a user may be provided an option to select a method or way of making one or more payments. In some embodiments, information that may be presented on a display screen may be influenced or dictated by the user's selection. For example, in some embodiments a user's selected method of payment may be displayed, as opposed to displaying, e.g., all possible ways to pay.

Aspects of this disclosure may readily be applied to, and adapted to be operative on, one or more communication systems. Those communication systems may include computer networks, television networks, satellite networks, telephone and cellular networks, and the like.

Although not required, various aspects described herein may be embodied as a method, a data processing system, and/or as one or more transitory and/or non-transitory computer-readable media storing executable instructions. Accordingly, those aspects may take the form of an entirely hardware embodiment, an entirely software embodiment, an entirely firmware embodiment, or an embodiment combining software, firmware and hardware aspects. The functionality may be resident in a single computing device, or may be distributed across multiple computing devices/platforms, the multiple computing devices/platforms optionally being connected to one another via one or more networks. Moreover, the structural components described herein may be distributed amongst one or more devices, optionally within a common housing or casing.

Various signals representing content, data, information, or events as described herein may be transferred between a source and a destination in the form of electromagnetic waves traveling through signal-conducting media such as metal wires, optical fibers, and/or wireless transmission media (e.g., air and/or space).

The various methods and acts may be operative across one or more computing servers, databases, and one or more networks. The functionality may be distributed in any manner, or may be located in a single computing device (e.g., a server, a database, a client computer, etc.). As discussed herein, content (e.g., product/service offerings and acceptances thereof) may be distributed to intermediary/network components and client-side devices at various times and in various formats. The distribution and transmission techniques described herein may leverage existing components and infrastructure to minimize power dissipation, operational complexity, footprint size, and management involvement, amongst other factors and costs.

The methodological acts and processes described herein may be tied to particular machines or apparatuses. For example, one or more product or service offerings may be transmitted to a user device or location via one or more computing devices (e.g., servers) and the offer(s) may be displayed at the user location via one or more terminals and/or display devices. One or more acceptances, rejections, and/or counter offers (e.g., user selections of options to be associated with a package of products/services) may be transmitted from a user device or location to one or more computing devices (e.g., servers). In some embodiments, (additional or supplemental) information regarding a user or a user's selections may be transmitted from a user device or location to one or more computing devices (e.g., servers). More generally, one or more apparatuses may include one or more processors and memory storing instructions, that when executed by the one or more processors, cause the one or more apparatuses to perform the methodological acts and processes described herein. Furthermore, the methodological acts and processes described herein may perform a variety of functions including transforming an article (e.g., products and services managed by disparate groups) into a different state or thing (e.g., a package of products and services with optimal terms and conditions).

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the figures may be performed in other than the recited order, and that one or more steps illustrated may be optional in accordance with aspects of the disclosure.

The appendices attached herewith include additional material. The appendices are incorporated herein by reference.

What is claimed is:

1. An apparatus comprising:
at least one processor; and
memory storing instructions that, when executed by the at least one processor, cause the apparatus to:
receive a selection from a client device, wherein the received selection is associated with an account,
determine that an option associated with the account needs to be modified in response to the received selection and based on a linkage with at least one additional account, and
provide the modified option to the client device responsive to the determination.

2. The apparatus of claim 1, wherein the modified option comprises a price associated with the account.

3. The apparatus of claim 1, wherein the instructions, when executed by the at least one processor, cause the apparatus to:
link the account with the at least one additional account responsive to a request received from the client device to link the accounts.

4. The apparatus of claim 1, wherein the instructions, when executed by the at least one processor, cause the apparatus to:
receive a response from the client device that accepts the modified option, and
responsive to receiving the response that accepts the modified option, perform at least one of:
establishing the account based at least in part on the received selection and the modified option, and
updating the account based at least in part on the received selection and the modified option.

5. The apparatus of claim 1, wherein the instructions, when executed by the at least one processor, cause the apparatus to:
request information from the client device, the requested information comprising log-in information and at least one of: a social security number, a residential address, a mailing address, an email address, a telephone number, date of birth, citizenship, identification of an employer, educational history, listing of dependents, an identification of one or more names to be associated with the account, and
receive the requested information from the client device,
wherein the selection is received from the client device responsive to determining that the requested information received from the client device is valid.

6. The apparatus of claim 1, wherein the instructions, when executed by the at least one processor, cause the apparatus to:
transmit a message to the client device, wherein the message comprises an offer with respect to the account based at least in part on an analysis with respect to the account,
receive the selection from the client device based at least in part on the transmitted message.

7. The apparatus of claim 1, wherein the modified option is based at least in part on a location of the client device.

8. A method comprising:
linking a bank account associated with a user to at least one additional account associated with the user;
analyzing, at an apparatus, the bank account based at least in part on the linkage;
determining, at the apparatus, at least one term or condition associated with the bank account that could be optimized based at least in part on the analysis; and
transmitting a message from the apparatus responsive to said determining, the message comprising a suggested value for the at least one term or condition.

9. The method of claim 8, wherein the linking is performed responsive to a user request received at the apparatus to link the bank account with the at least one additional account.

10. The method of claim 8, further comprising:
transmitting, from the apparatus, a request for the user to link the bank account with the at least one additional account responsive to the user logging-in to a site associated with a bank; and
receiving, at the apparatus, a response from the user agreeing to the linking,
wherein the linking occurs responsive to receiving the user's agreement to the linking, and
wherein the at least one additional account is associated with the bank.

11. The method of claim 8, wherein the bank account is associated with at least one of: debit/credit card transactions, checking, bill pay, a mortgage, savings, investments, and online banking.

12. The method of claim 8, further comprising:
receiving, at the apparatus, a message from the user accepting the suggested value; and
performing at least one of:
establishing the bank account based on the suggested value; and
updating the bank account based on the suggested value.

13. One or more non-transitory computer-readable media comprising instructions that, when executed by an apparatus, cause the apparatus to:
package a plurality of banking services by linking a plurality of bank accounts associated with a user,
transmit an offer to the user to modify at least one term or condition associated with at least one of the bank accounts based at least in part on the linkage,
receive an acceptance of the offer from a client device associated with the user, and
implement the modified at least one term or condition associated with the at least one of the bank accounts.

14. The one or more non-transitory computer-readable media of claim 13, wherein the instructions, when executed by the apparatus, cause the apparatus to:
receive a selection from the client device that indicates a desire to modify a second term or condition associated with at least one of the accounts, and
responsive to receiving the selection, providing a modified value for a third term or condition associated with at least one of the accounts substantially in real-time.

15. The one or more non-transitory computer-readable media of claim 13, wherein the instructions, when executed by the apparatus, cause the apparatus to:
receive a request from the client device to provide a combined statement based on the linked plurality of bank accounts, and
provide the combined statement responsive to the request.

16. The one or more non-transitory computer-readable media of claim 13, wherein the instructions, when executed by the apparatus, cause the apparatus to:
receive a request from the client device to link the plurality of bank accounts,
wherein the plurality of banking services are packaged based on the received request, and
wherein a pricing of the plurality of banking services to the user is reduced based on the packaging.

17. The one or more non-transitory computer-readable media of claim 13, wherein the instructions, when executed by the apparatus, cause the apparatus to:
designate at least a first of the plurality of user accounts as a source of funds to provide protection for at least a second of the plurality of user accounts.

18. The one or more non-transitory computer-readable media of claim 17, wherein the instructions, when executed by the apparatus, cause the apparatus to:
receive the designation from the client device.

19. The one or more non-transitory computer-readable media of claim 18, wherein the modified at least one term or condition is based on the designation.

20. The one or more non-transitory computer-readable media of claim 13, wherein the at least one term or condition is based at least in part on a location of the user, and wherein the at least one term or condition comprises an option for the user to specify how to make a payment.
